(19) United States
(12) Patent Application Publication
(10) Pub. No.: US 2016/0266860 A1
(43) Pub. Date: Sep. 15, 2016

(54) MULTIUSER INTERACTIVE DISPLAY SYSTEM AND METHOD

(71) Applicant: Sensory Technologies LLC, Indianapolis, IN (US)

(72) Inventor: SUNGWONG NAM, Whitestown, IN (US)

(21) Appl. No.: 15/063,564

(22) Filed: Mar. 8, 2016

Related U.S. Application Data
(60) Provisional application No. 62/130,380, filed on Mar. 9, 2015.

(51) Int. Cl. G06F 3/14; H04L 29/06; G06F 3/0481

(52) U.S. Cl. CPC G06F 3/1446; G06F 3/04812; H04L 65/403

(57) ABSTRACT

A video display wall system for displaying information provided by a plurality of computing devices each interacting with the video display wall system at the discretion of a user. The display wall system includes a video display wall and a server operatively coupled to the display wall and to the plurality of computing devices. The system is configured to enable each of the users to concurrently display information on the display wall, as well as to enable concurrent interaction by each of the users with the displayed information. The owner of the displayed information and the identity of each of the users interacting with the displayed information are maintained by the server. A method for multiple users to concurrently interact with shared media that is displayed, and a multiuser interactive display system is described.

### RELATED APPLICATION

This application claims priority to U.S. Provisional Patent Application Ser. No. 62/130,380 entitled “Multiuser Interactive Display System and Method”, filed Mar. 9, 2015, the disclosure of which is incorporated by reference herein in its entirety.

### BACKGROUND

The present disclosure relates to systems and methods for providing a multiuser interactive display system, whereby multiple users can login simultaneously to and share the same computer-based graphical workspace, share individual content, and interact with the shared contents concurrently in a virtual graphical desktop environment.

The ability to interpret and digest various digital data and information produced by various sources is important. As huge amounts of digital data and information are generated every day at continually increasing volumes, the need exists for an effective way to present these information and data for easy filtering, comparison and analysis.

Ultra-high resolution single panel monitors and large-scale tiled display walls are often used for information and data presentations of, for example, images, video, pdf documents, live streams (including audiovisual conferencing), and other types of media files.

Traditionally, large-scale tiled display walls could only be built with a cluster of computers. This requirement has been the major barrier that prevents wider range of users from adapting or transitioning to display wall technologies, due to the cost and complexity required to build and maintain a computer cluster. With the advent of modern multi-headed graphics hardware, however, users can now more easily build ultra-high resolution display walls. FIG. 1A shows an example of a 4×3 display wall 20 defined by twelve 1080p (1920×1080 pixels) display units 22 which may be high-definition TV units. The respective display units 22 in display wall 20 are enumerated 1-12 in FIG. 1A.

Display units 22 can be run by a single workstation with hardware that includes multiple head high-end graphics cards. Major graphics hardware manufacturers such as NVIDIA, AMD, and Matrox, for example, provide multi-head graphics display technologies, such as NVIDIA Mosaic, AMD Eyefinity, and Matrox PowerDesk. Any of these products can enable generation of a single virtual desktop screen over the array of tiled, multiple display units 22 to provide a single, ultra-high resolution graphical workspace on a virtual screen defined by display wall 20. Display wall 20 can thus comprise a tiled array of high definition display units 22 over which seamlessly spans a large, ultra-high resolution display 24. Alternatively, display 24 may be provided on a single panel monitor, which may be a single one of display units 22.

FIG. 1B shows a fragmented, partial view of a single workstation or personal computer (“PC”) 26 having three four-head NVIDIA Quadro K5200 graphics cards 28, 30 and 32. The four outputs of each graphics card 28, 30, 32 are each connected by a respective cable to a particular one of enumerated display units 22 of FIG. 1A, and are accordingly enumerated with a corresponding output number 1-12. Assuming each display unit 22 of display wall 20 is a typical high-definition TV (1920×1080 resolution), the total resolution of the display wall is 7680×3240 pixels. The tiled display wall 20 can thus enable the display of numerous high-resolution images and videos displayed in their native resolution simultaneously. Alternatively, workstation 26 may include a single graphics card connected to a single panel monitor. The discussion that follows relates to a workstation and display wall as depicted in FIGS. 1A and 1B, but generally applies as well to the case of a workstation connected to a single panel monitor.

Traditional graphical desktop operating systems are designed based on the assumption that a single user physically interacts with the workstation 26 using a keyboard and a mouse (not shown). There can be multiple different user accounts and multiple users can remotely login simultaneously. However, multiuser collaboration where multiple users sit together in the same room and simultaneously interact with contents displayed on a single common display wall is highly limited because only a single user can directly interact with graphical contents on PC 26. In other words, such graphics desktop operating systems are presently designed for a single user interaction scheme, in which a single user owns the graphical desktop environment. A user gains access to a desktop session of a computer system by logging in with his user credential, which enables a shared system to provide each user a separate private workspace. Once a user has logged in, the desktop session is owned by the user. Therefore, this traditional design does not allow multiple users to login to the same graphical desktop workspace concurrently. Such systems are limited in that they allow only the single user currently logged in to the PC 26 to access the graphical contents he shares and have the ability to interact with that content. When such a PC is attached to display wall 20, the display wall's potential as a multiuser collaborative environment remains similarly limited. Display wall systems utilizing the traditional scheme (i.e., a graphical desktop space owned by a single user) that allow contents from separate sources to be visualized simultaneously can limit the collaboration capability of the display wall environment.

It is desirable to resolve this limitation, and provide a single virtual graphical desktop environment in which multiple users can simultaneously login to and share the same workspace, share individual content, and concurrently interact with the shared contents.

Many user environments or forums would benefit from the provision of such a virtual graphical desktop environment. One such example is education. The classroom environment is changing rapidly as students rarely absorb lectures passively from their desks. Decades of research speak to the educational benefits of active learning; however, this paradigm shift in how information is shared, created and exchanged challenges those seeking to provide rich learning experiences. These challenges can be met by providing a virtual blackboard where instructors and students could share various media simultaneously and concurrently interact with the media, enhancing the learning experience. Such an interactive graphical desktop environment can be further enhanced by being adapted to include a large-scale display wall instead of or in addition to a single panel monitor.

Another user environment or forum that stands to benefit from utilizing such an interactive graphical desktop environment is business enterprise. The “more heads are better” philosophy is widely accepted by businesspeople, and the benefits of collaboration by individuals with a sense of shared purpose are well documented. Businesses could more effectively generate, funnel and capture the collaborative synergy while it happens by utilizing a highly collaborative virtual graphical desktop environment capable of displaying digital content from multiple sources in various formats that allows multiple users to instantly share information, and annotate the shared content simultaneously. Facilitating such multiuser collaboration could greatly improve business productivity, more so if it also involves use of a large-scale display wall instead of or in addition to a single panel monitor.

In the era of big data, synthesizing information challenges the most expert thought leaders. Even more difficult can be the task of communicating aggregate insights concurrently contributed from multiple sources to others needing to understand the big picture. Thus, another user environment or forum that could benefit from facilitating such collaboration by multiple specialists is healthcare.

### SUMMARY

The present disclosure beneficially provides a multiuser interactive display system that enables improvements in the abilities of individuals and groups to interpret and digest digital data and information. The display system may include a single panel monitor, or be adapted to include a large-scale display wall.

The disclosed multiuser interactive display system (the “system”), an embodiment of which may become known as Thrive, includes a computer software package designed to improve multiuser collaborative experiences in an environment having a single panel monitor and/or a large, ultra-high resolution tiled display wall. The system achieves this by allowing multiple users to share the same graphical workspace and interact with contents in the workspace simultaneously while maintaining awareness of content ownership and being able to distinguish between each user's interactions with the respective content.

The system software consists of two independent applications: the system software server (system server) and the system software client (system client). The system server runs in a high-performance graphics workstation that, in certain embodiments, is connected to the multiple display units of a display wall. In such embodiments, the system server provides a single virtual graphical desktop workspace that seamlessly spans across the tiled display units. Alternatively, the workstation is connected to a ultra-high resolution single panel monitor providing the same graphical workspace in a smaller dimension. Regardless of the display configuration, the system software enables multiuser interactivity. The system client runs in each user's individual input device (typically a laptop) and is used to communicate (preferably wirelessly) with the system server for the users to share content displayed on the display wall, and remotely interact with shared content using their respective individual input devices.

The disclosed system facilitates a highly collaborative, shared workspace because it can display multiple digital contents simultaneously to the collaborating users, and allow the users to interact with the various displayed contents concurrently.

In one embodiment, there is provided a method for manipulating the display of information shown on a video display including, receiving at a server, a plurality of transmitted information files, each of the plurality of transmitted information files begin transmitted by a different one of a plurality of computing devices. The method includes establishing at the server a plurality of communication channels, wherein each of the plurality of communication channels is dedicated to a different one of the plurality of computing devices. The method further includes retaining each of the plurality of transmitted information files on the server and displaying each of the plurality of transmitted information files concurrently on the display.

In another embodiment, there is provided a method for processing multiple user interactions with information shown on a video display wall including storing at a server a plurality of information files transmitted by a plurality of computing devices. The method further includes displaying on the display wall each of the plurality of stored information files and associating one of a plurality of graphical user interface components with a specific one of the plurality of computing devices. The method also includes displaying on the display wall the graphical user interface component for each of the plurality of computing devices, wherein the displayed graphical user interface component is directly controlled by the associated one of the plurality of computing devices.

In still another embodiment, there is provided a video display wall system for displaying information provided by a plurality of computing devices each interacting with the video display wall system at the discretion of a user including a display wall and a system server. The system server is operatively coupled to the display wall and to the plurality of computing devices. The system server includes a communication manager, configured to receive a plurality of transmitted interaction messages from each of the plurality of computing devices, a file manager, a scene renderer and a multiuser interaction manager. The file manager is configured to receive a media file from each of the plurality of computing devices. The scene renderer is configured to render the media file from each of the plurality of computing devices for display on the display wall as the video information. The multiuser interaction manager is configured to direct interactions of each of the plurality of the computing device with the displayed video information based on the received interaction messages.

### BRIEF DESCRIPTION OF THE DRAWINGS

The above-mentioned aspects and other characteristics and advantages of a method or system according to the present disclosure will become more apparent and will be better understood by reference to the following description of exemplary embodiments taken in conjunction with the accompanying drawings, wherein:

FIG. 1A depicts a 4×3 tiled display wall utilized in an embodiment of the disclosed system, wherein each display unit is a typical high-definition TV and over which is provided a single virtual desktop screen;

FIG. 1B is a fragmented, partial view of a single workstation utilized in an embodiment of the disclosed system for driving the display wall of FIG. 1A;

FIG. 2 is a schematic representation of a multiuser interaction scheme according to an embodiment of the disclosed system;

FIG. 3 is schematic representation of an embodiment of the system software structure showing major software modules included in the system server and each system client;

FIG. 4 is a multiuser interaction diagram for an embodiment of the disclosed system; and

FIG. 5 shows the abstract class hierarchy of applications and GUI components which comprise an instance of graphical content and are concurrently interactable by multiple users.

Corresponding reference characters indicate corresponding parts throughout the several views.

### DESCRIPTION

The embodiments described below are not intended to be exhaustive or to limit the invention to the precise forms or steps disclosed in the following detailed description, but have been chosen and are herein described so that others skilled in the art may appreciate and understand principles and practices according to the present disclosure, and may utilize their teachings. It is, therefore, to be understood that the invention herein described is not limited in its application to the details set forth in the following description or illustrated in the following drawings, and is capable of having other embodiments and of being practiced or of being carried out in various ways.

The present disclosure may be practiced with “object-oriented” software, and particularly with an “object-oriented” operating system. The “object-oriented” software is organized into “objects,” each typically including a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and having knowledge to carry out processes. Messages are generated in response to user instructions, for example, by a user activating an icon with a “mouse” pointer and thereby generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of an object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by messages effects an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences and combinations of message and response may continue or may come to an end when all messages have been responded to and no new messages are being sent. When modeling systems utilize an object-oriented language, a programmer need only think in terms of how each component of a modeled system responds to a stimulus and not in terms of the sequence of operations to be performed in response to some stimulus. Such a sequence of operations naturally flows out of the interactions between the objects in response to the stimulus, and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works by simply observing the readily apparent manifestations of its operation. Most of the operations carried out by a computer in response to a program are “invisible” to an observer because typically only a relatively few steps in a program produce an observable computer output.

Several terms which are used frequently have specialized meanings in the present context. The term “object” relates to a set of computer instructions and associated data which can be activated directly or indirectly by the user. The terms “windowing environment,” “running in windows,” and “object-oriented operating system” are used to denote a computer user interface in which information is manipulated and displayed on a video display such as within bounded regions on a raster scanned video display. The terms “network,” “local area network,” “LAN,” “wide area network,” and “WAN” refer to two or more computers which are connected so that messages may be transmitted between the computers. In such computer networks, typically one or more computers operate as a “server,” a computer with large storage devices such as hard disk drives and communication hardware to operate peripheral devices such as display walls, printers or modems. Other computers provide a user interface so that users of computer networks can access network resources, such as shared data files, common peripheral devices, and inter-computer communication. Users activate computer programs or network resources to create “processes” which include both the general operation of the computer program along with operations having specific characteristics determined by input variables and environment.

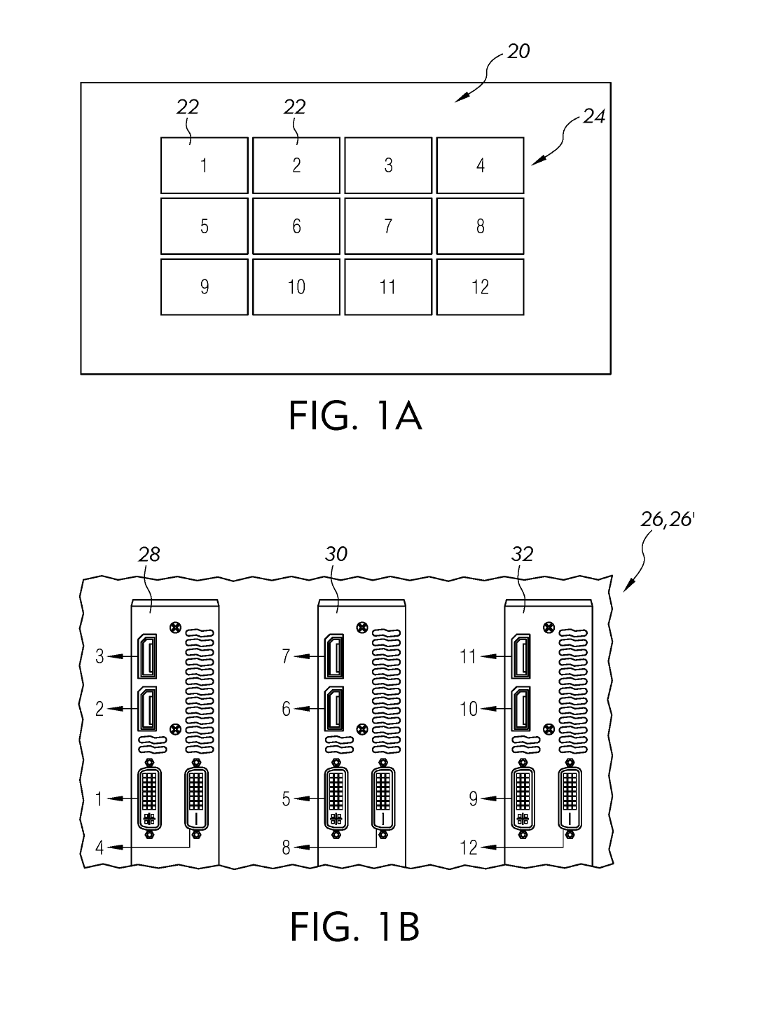

The embodiment of multiuser interactive display system 18 (i.e., system 18 or “the system”) described herein includes display wall 20 as described above. It is to be understood, however, that certain embodiments of system 18 may be adapted to instead or additionally include one or more single panel monitors to provide display 24. System 18 also utilizes a single workstation or PC 26′, a portion of which is shown in FIG. 1B. Workstation 26′ is structurally similar to above-described workstation 26, and may include identical hardware such as four-head NVIDIA Quadro K5200 graphics cards 28, 30 and 32. As in the case with prior workstation 26, the four outputs of each graphics card 28, 30, 32 of workstation 26′ are each connected by a respective cable to a particular one of enumerated display units 22 of display wall 20 shown in FIG. 1A. The graphics card outputs of workstation 26′ are likewise accordingly enumerated 112. Workstation 26′ differs significantly from prior workstation 26, however, in that workstation 26′ includes system software enabling it to function as the server of system 18 (the “system server”, or system server 46).

The multiuser interaction model of system 18 provides a virtual graphical desktop session (a workspace) to which multiple users can login, share contents, and interact concurrently. There are two fundamental premises of enabling multiuser interactivity:

(1) A mechanism is provided that can concurrently receive multiple users' interaction messages and execute those interactions. This premise provides a notion of the shared desktop workspace where each participating user can use his own input device/laptop to interact with the shared content.

(2) Graphical objects appearing on the display wall can be concurrently interacted with, and the system server is aware of which user is interacting with those graphical objects. This premise maintains ownership information of the media and the interactions in the shared workspace where different users can share and interact simultaneously.

Thus the core of the multiuser collaborative environments enabled by system 18 consists of the mechanism that allows multiple users to stream their input device events concurrently and the newly designed graphical user interface (GUI) components that are aware of multiuser interactions on them.

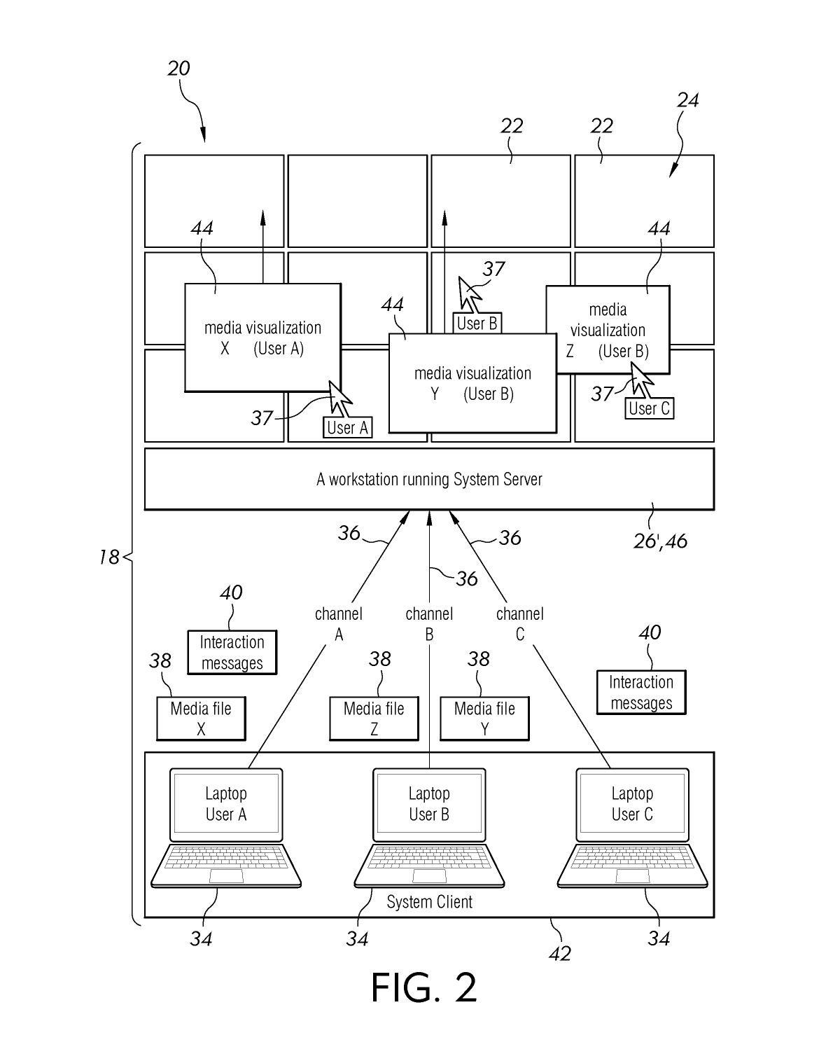

FIG. 2 shows an example multiuser interaction scheme. In this example three users utilizing input devices 34 such as laptop computers (individually referred to as Laptop Users A, B, and C) are sharing their media with display wall 20 (FIG. 1A) run by single workstation 26′ (FIG. 1B). Transmission of the shared media from each respective Laptop User A, B or C to workstation 26′ is over an associated wireless communication channel 36 (respectively referred to as channel A, B or C). Whenever a user connects to system server 46 of workstation 26′ a dedicated communication channel 36 is established between the system server and that user. The system server also creates a graphical mouse pointer 37 for that user upon establishment of the dedicated communication channel 36, and these graphical pointers work the same as mouse pointers in a traditional graphical desktop environment. By establishing a dedicated communication channel for each user, ownership information about the shared media files 38, interaction messages 40, and graphical mouse pointers 37 are retained in system server 46.

The users interact with the displayed shared media using their respective individual input devices 34 connected to or built in their laptops. Each laptop 34 has installed on it the system software client, which enables the laptop to function as one of a plurality of system clients 42. In the depicted example, Laptop User A and Laptop User B share media files 38 using the respective laptop's system client 42. The shared media files 38 are, as shown, media file X shared by Laptop User A, and media files Y and Z shared by Laptop User B. These media files 38 are transmitted over the respective wireless communication channels 36 to the workstation 26′ where system server 46 is running. System server 46 then provides visualizations 44 of those media on display wall 20.

The interactions of each user with the shared media visualizations 44 occur in the user's respective input device/laptop 34 in real time. In this example, Laptop User A and C respectively interact with media visualization X and media visualization Z. The respective system client 42 translate the user interactions of Laptop User A and Laptop User C occurring in their devices in real time and transmit them as interaction messages 40 over the respective wireless channel A or C to system server 46. Upon receiving these interaction messages 40, system server 46 interprets the interaction messages 40 and correspondingly interacts with the media visualization 44 on display wall 20 on behalf of the particular user from whom the interaction message 40 was sent. In the depicted example, system server 46 interacts with media visualization X (shared by Laptop User A) on behalf of Laptop User A, and with media visualization Z (shared by Laptop User B) on behalf of Laptop User C.

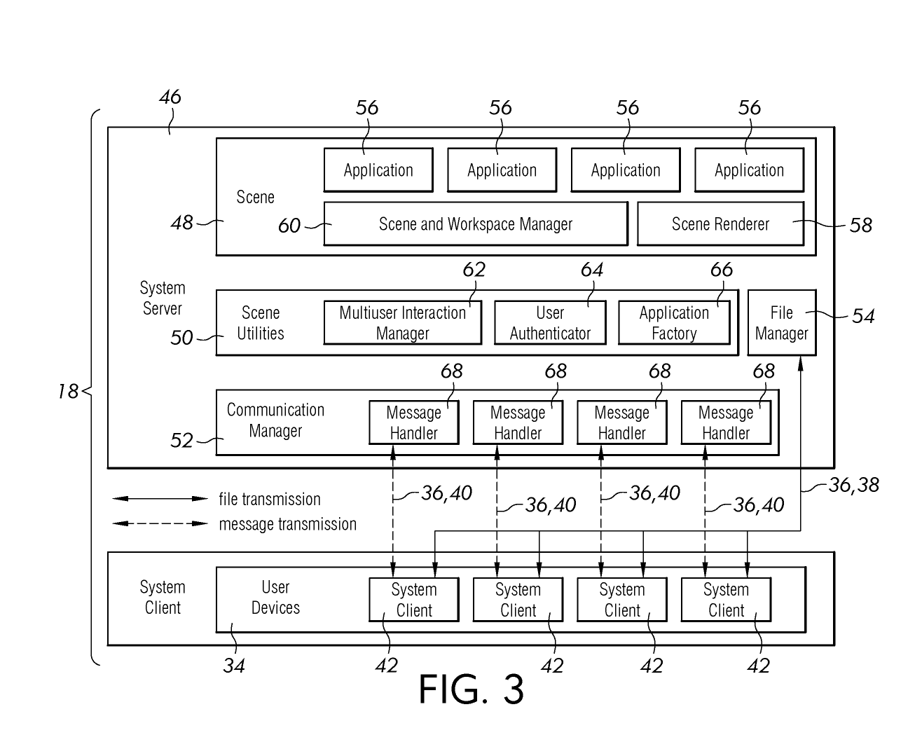

The overall software architecture of system 18 can be understood with reference to FIG. 3, which illustrates the software structure of the system as a diagram showing major software modules that define system server 46 and each system client 42. The various core software components of system server 46 include scene layer 48; scene utilities layer 50, communication manager layer 52, and file manager 54. Core software components in scene layer 48 include: applications 56 responsible for managing instances of classes that visualize the shared media; scene renderer 58 that has a hardware accelerated graphics context that renders the scene; and scene and workspace manager 60, a global object that holds all of the application instances in workspaces. Each application supports a respective media type such as images, videos, PDF documents and live streams such as a screen mirroring (VNC). The scene represents the set of visible elements of display wall 20 and components in scene utilities layer 50 are used to bridge user interactions to scene layer 48.

Core software components in scene utilities layer 50 include: multiuser interaction manager 62; user authenticator 64; and application factory 66.

Core software components in communication manager layer 52 include a plurality of message handlers 68 each associated with the respective, user-specific system client 42 of a user's input device 34. Message transmissions between system server 46 and the respective user input devices 34 are between the respective message handler 68 of communication manager layer 52 and the system client 42 running in the corresponding user's laptop.

File transmissions between system server 46 and the respective user input devices 34 are between file manager 54 of system server 46 and the system client 42 of each user input device 34.

One of the main goals of system server 46 is enabling a virtual collaborative graphical desktop workspace in which multiple users can simultaneously interact with and alter the scene. Once a user communicates through communication manager layer 52, then scene utilities layer 50 takes necessary actions to alter the scene content. Multiuser interactivity is enabled mainly by communication manager layer 52 and multiuser interaction manager 62 of system server 46. Each message handler 68 in communication manager layer 52 is a separate thread that handles the communication between system server 46 and the system client 42 of a particular user. This allows the interaction messages 40 from multiple users to be received concurrently at communication manager layer 52. Communication manager layer 52 then serializes those concurrently communicated interaction messages 40 and forwards them to multiuser interaction manager 62 sequentially.

The sharing of media files 38 through system client 42 is handled by file manager 54 of system server 46. Whenever file manager 54 receives a media file 38 of a particular type it notifies application factory 66 of scene utilities layer 50, wherein an instance of the corresponding application 56 for that file type is created. Application factory 66 then gives the application instance to scene and workspace manager 60 of scene layer 48. The application instance is visualized by scene renderer 58 of scene layer 48 and directed to display wall 20 through graphics card(s) 28, 30, 32.

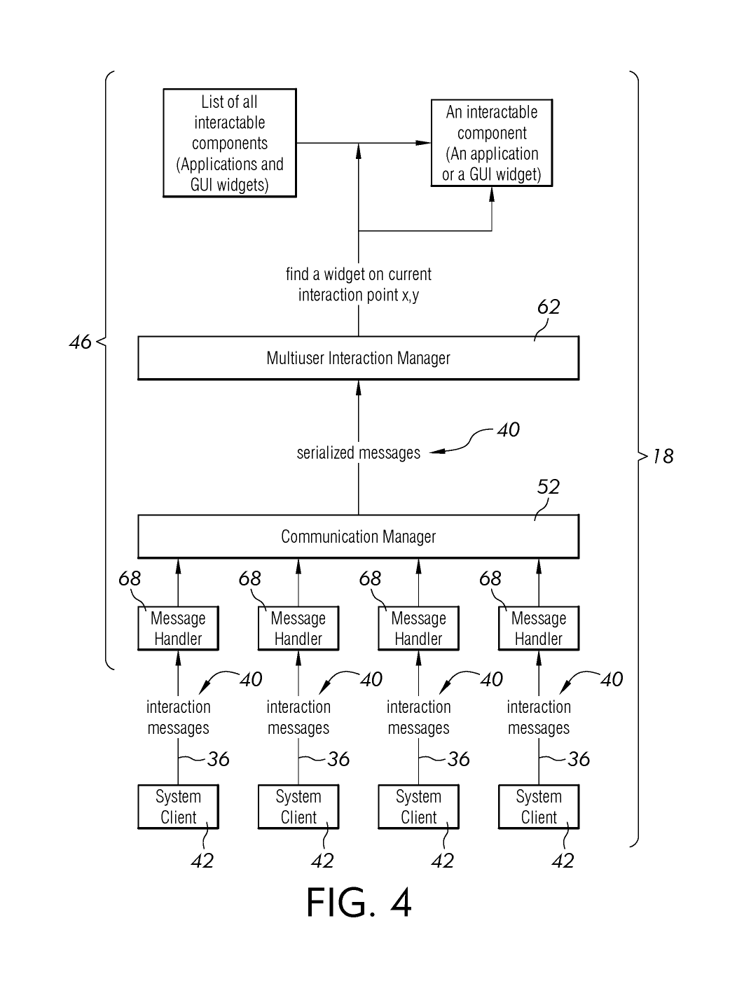

FIG. 4 is a multiuser interactions diagram. Interaction messages 40 from the users' system client 42 are received individually by the message handler 68 and serialized by communication manager 52 of system server 46. Multiuser interaction manager 62 of scene utilities layer 50 then receives the serialized interaction messages and interacts with a particular component on behalf of the user. FIG. 4 shows how users' interactions are forwarded from system client 42 to system server 46 and can be directed to a particular component, i.e., an application or GUI widget with which a user is interacting. The system client 42 running in each user's input device 34 captures that machine's input device events and creates interaction messages 40 describing the user's alteration to the visualized media. These interaction messages 40 are securely sent over a network (preferably a wireless network of known type) and handled by the message handler 68 of communication manager layer 52 of system server 46. The main job of communication manager 52 is to serialize the interaction messages 40 concurrently received by the plurality of message handlers 68 from their respectively associated system client 42. Once these interaction messages 40 are serialized, the serialized interaction messages 40 are delivered sequentially to multiuser interaction manager 62 of scene utilities layer 50. Multiuser interaction manager 62 then finds a component (i.e., a GUI widget or application) that can be interacted with on the point at which the current interaction occurs, and applies the interaction on behalf of the user.

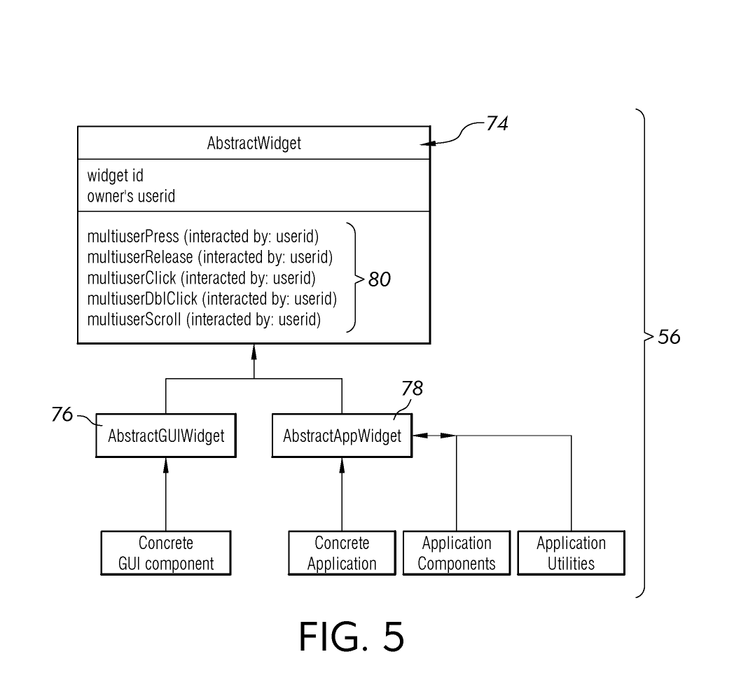

FIG. 5 is a class diagram showing the abstract class hierarchy of an instance of applications 56 of scene layer 48 and GUI components that are concurrently interactable by multiple users, i.e., “concrete” applications and GUI components. Multiuser interaction manager 62 applies each user's interaction by invoking the component's methods abstractly defined in a class 74 called AbstractWidget as shown in FIG. 5.

AbstractWidget 74 is the base class of all multiuser-aware GUI components (the concrete GUI component class that inherits AbstractGUlWidget 76) and the GUI applications (the concrete application class that inherits AbstractAppWidget 78). These GUI components and GUI applications provide responses to user interactions by reimplementing handler functions 80 that are prototyped in AbstractWidget 74. As shown in FIG. 5, handler functions include multiuserPress, multiuserRelease, multiuserClick, multiuserDblClick, and multiuserScroll. Handler functions 80 receive a user id as a function argument which enables all the graphical components that inherit AbstractWidget. The GUI components and GUI applications are thus able to distinguish with whom they are interacting. Once the multiuser interaction manager 62 finds an interactable instance (either a GUI component or a GUI application) for an interaction occurring at a particular point on display wall 20, multiuser interaction manager 62 then simply invokes the handler function(s) 80 of the widget with the unique user identifier so that the widget can be aware of whom it is interacting with.

While exemplary embodiments incorporating the principles of the present invention have been disclosed hereinabove, the present invention is not limited to the disclosed embodiments. Instead, this system software is intended to cover any variations, uses, or adaptations of the invention using its general principles. Further, this system software is intended to cover such departures from the present disclosure as come within known or customary practice in the art to which this invention pertains and which fall within the limits of the appended claims.

What is claimed is:

1. A method for manipulating the display of information shown on a video display, the method comprising:
receiving at a server, a plurality of transmitted information files, each of the plurality of transmitted information files begin transmitted by a different one of a plurality of computing devices;
establishing at the server a plurality of communication channels, wherein each of the plurality of communication channels is dedicated to a different one of the plurality of computing devices;
retaining each of the plurality of transmitted information files on the server; and
displaying each of the plurality of transmitted information files concurrently on the display.

2. The method of claim 1 further comprising:
establishing a plurality of message handling threads for the each of the plurality of computing devices, wherein each of the plurality of message handling threads is distinct from another one of the plurality of message handling threads and each is configured to concurrently handle an interaction message transmitted by the plurality of computing devices.

3. The method of claim 2 further comprising:
serializing, at the server, each of the plurality of transmitted interaction messages; and
enabling interaction, by each of the plurality of computing devices, with any one of the displayed plurality of transmitted information files, wherein the enabled interaction results from the interaction messages transmitted by each of the plurality of computing devices.

4. The method of claim 3 wherein the displaying each of the plurality of transmitted information files includes displaying a graphical component, identified by one of the plurality of interaction messages, at one of the displayed plurality of transmitted information.

5. The method of claim 4 wherein the graphical component includes one of a plurality of graphical components.

6. The method of claim 5 wherein the plurality of graphical components is identified by the interaction message transmitted by the plurality of computing devices.

7. The method of claim 6 wherein the plurality of graphical components includes one of a pointer or visual feedback of one of a plurality of actions including press, release, click, double click and a scroll.

8. A method for processing multiple user interactions with information shown on a video display wall, the method comprising:
storing, at a server, a plurality of information files transmitted by a plurality of computing devices;
displaying on the display wall each of the plurality of stored information files;
associating one of a plurality of graphical user interface components with a specific one of the plurality of computing devices; and
displaying on the display wall the graphical user interface component for each of the plurality of computing devices, wherein the displayed graphical user interface component is directly controlled by the associated one of the plurality of computing devices.

9. The method of claim 8 wherein the displaying on the display wall the graphical user interface component includes displaying the displayed graphical user interface component of the associated one of the plurality of computing devices at any one of displayed plurality of stored information files.

10. The method of claim 9 wherein the displaying the displayed graphical user interface component includes displaying an interaction of at least two of the plurality of graphical user interface components with one of the displayed information files.

11. The method of claim 9 further comprising:
concurrently receiving at the server the plurality of information files transmitted by each of the plurality of computing devices; and
concurrently displaying an interaction of each of the graphical user interface components with each of the plurality of displayed information files.

12. The method of claim 11 wherein the displayed graphical user interface component includes a graphical pointer having displayed ownership information configured to identify which one of the plurality of computing devices controls movement of the graphical pointer.

13. The method of claim 12 further comprising a receiving at the server a plurality of messages concurrently transmitted by each of the plurality of computing devices, wherein each of the plurality of messages provides to the server an interactable instance for an interaction occurring at a particular point on the display wall.

14. The method of claim 13 further comprising serializing at the server each of the received plurality of messages concurrently transmitted by each of the plurality of computing devices.

15. The method of claim 11 further comprising displaying on the display wall a multiuser graphical user interface component, wherein the multiuser graphical user interface component is interactable by each of the plurality of computing devices.

16. The method of claim 15 further comprising concurrently displaying on the display wall the interaction by each of the plurality of the computing devices with the multiuser graphical user interface component.

17. A video display wall system for displaying information provided by a plurality of computing devices each interacting with the video display wall system at the discretion of a user, the video display wall system including:
a display wall; and
a system server operatively coupled to the display wall and to the plurality of computing devices, the system server including:
a communication manager configured to receive a plurality of transmitted interaction messages from each of the plurality of computing devices;
a file manager configured to receive a media file from each of the plurality of computing devices;
scene renderer configured to render the media file from each of the plurality of computing devices for display on the display wall as the information; and
a multiuser interaction manager configured to direct interactions of each of the plurality of the computing device with the displayed information based on the received interaction messages.

18. The video display wall system of claim 17 wherein the communication manager module is further configured to concurrently receive each of the plurality of interaction messages from each of the plurality of computing devices and to serialize the concurrently received plurality of interaction messages.

19. The video display wall system of claim 18 wherein the multiuser interaction manager is further configured to receive the serialized plurality of interaction messages.

20. The video display wall system of claim 17 wherein the multiuser interaction manager is further configured to identify a graphical user interface component identified by at least two of the interaction messages and to apply each of the interaction messages to the identified graphical user interface component.
